(19) United States
(12) Patent Application Publication
(10) Pub. No.: US 2025/0244912 A1
(43) Pub. Date: Jul. 31, 2025

(54) ZONE WRITING AND MAINTENANCE FOR MEMORY SYSTEMS

(71) Applicant: Micron Technology, Inc., Boise, ID (US)

(72) Inventors: Hong Lu, San Jose, CA (US); Eric Yuen, Dublin, CA (US); Luca Porzio, Casalnuovo (NA) (ID); Rakeshkumar Dayabhai Vaghasiya, Hyderabad (IN); Cun Chen, Shanghai (CN); Xiao Wang, Shanghai (CN)

(21) Appl. No.: 19/020,941

(22) Filed: Jan. 14, 2025

Related U.S. Application Data
(60) Provisional application No. 63/627,601, filed on Jan. 31, 2024.

(51) Int. Cl. G06F 3/06

(52) U.S. Cl. CPC G06F 3/0655; G06F 3/0604; G06F 3/0665; G06F 3/0679

(57) ABSTRACT

Methods, systems, and devices for zone writing and maintenance for memory systems are described. A memory system may support a zoned write operation, where data associated with a preferred zone may be written with a first cursor, and data associated with other zones may be written with one or more second cursors. For example, a zone associated with a highest access frequency may be written using a single-level cell cursor, and other zones may be written using a higher-level cursor, such as a triple-level cursor. After writing the zones to a quantity of virtual blocks, a maintenance operation may be performed to reorder the zones within the quantity of virtual blocks according to access frequencies of the zones. Additionally, performing the maintenance operation may include performing garbage collection for the zones, such that invalid zones may be erased and valid zones may be reconsolidated within the quantity of virtual blocks.

### CROSS REFERENCE

The present Application for Patent claims priority to U.S. Patent Application No. 63/627,601 by Lu et al., entitled “ZONE WRITING AND MAINTENANCE FOR MEMORY SYSTEMS,” filed by Jan. 31, 2024, which is assigned to the assignee hereof, and which is expressly incorporated by reference in its entirety herein.

### TECHNICAL FIELD

The following relates to one or more systems for memory, including zone writing and maintenance for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports zone writing and maintenance for memory systems in accordance with examples as disclosed herein.

FIG. 2 shows an example of a zone architecture that supports zone writing and maintenance for memory systems in accordance with examples as disclosed herein.

FIG. 3 shows an example of a maintenance diagram that supports zone writing and maintenance for memory systems in accordance with examples as disclosed herein.

FIG. 4 shows a block diagram of a memory system that supports zone writing and maintenance for memory systems in accordance with examples as disclosed herein.

FIG. 5 shows a flowchart illustrating a method or methods that support zone writing and maintenance for memory systems in accordance with examples as disclosed herein.

### DETAILED DESCRIPTION

Some memory systems may implement a zoned architecture in which data may be written as part of one or more open zones (e.g., up to a quantity of open zones) of the memory system. For example, the memory system may support a quantity of open zones, and the memory system may implement a quantity of cursors (e.g., write pointers) for writing data associated with the quantity of open zones (e.g., a cursor for each open zone) to a memory array. In some cases, writing data may include opening a block (e.g., a virtual block) of the memory array and allocating a portion of a write buffer for writing the data. In some such cases, the data may be temporarily written to the write buffer using a cursor associated with the respective zone, and then transferred to the open block. However, implementing a relatively large quantity of open zones may involve using a relatively large quantity of cursors. Likewise, implementing a relatively large quantity of open zones may involve a relatively large consumption of the write buffer storage capacity. Thus, implementing the zoned architecture may involve relatively high system resource utilization, which may increase system overhead and processing times for completing zoned write operations of the memory system, among other challenges.

In accordance with examples as described herein, a memory system may support a zoned write operation, in which data associated with a preferred zone (e.g., temperature) may be written with a first cursor, and data associated with other zones may be written with one or more second cursors. For example, a zone associated with a highest access frequency (e.g., a highest temperature) may be designated as a preferred zone, and may be written to the memory system using a first cursor, such as a single-level cell (SLC) cursor, such that the data associated with the preferred zone is written to SLCs of the memory system. In some such examples, other zones may be written to the memory system using a second cursor, such as a triple-level cell (TLC) cursor, a quad-level cell (QLC) cursor, or some other multi-level cell (MLC) cursor, among other examples, such that the data associated with the other zones is written to TLCs, MLCs, or QLCs of the memory system, among other examples. After writing the data associated with the zones (e.g., the preferred zone and the other zones) to a quantity of virtual blocks of the memory system (e.g., using the respective cursors), the data may be zonified to separate the data into the respective zones, and a maintenance operation may be performed to reorder the zones (e.g., and the corresponding data) within the quantity of virtual blocks in accordance with access frequencies of the zones. Access frequencies may be related to temperature of the zones, among other access frequency metrics. Additionally, performing the maintenance operation may include performing garbage collection for the zones, such that invalid zones may be erased and valid zones may be reconsolidated within the quantity of virtual blocks. In some cases, performing the maintenance operation may include folding data associated with the preferred zone from one area to another such as from the SLCs to the TLCs. Implementing the zoned write operation as described herein may support a reduced quantity of cursors and/or a reduced consumption of write buffer storage capacity for writing the zone data, thereby reducing system resource utilization and decreasing system overhead. Additionally, or alternatively, performing the zoned write operation may support a reduced garbage collection frequency, a reduced address mapping table size associated with accessing the zone data, and improved random read latency, among other benefits.

In addition to applicability in memory systems as described herein, techniques for zone writing and maintenance for memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by establishing a zoned architecture with relatively reduced system resource utilization, which may decrease processing or latency times, improve response times, or otherwise improve user experience, among other benefits.

Features of the disclosure are illustrated and described in the context of systems, devices, and circuits. Features of the disclosure are further illustrated and described in the context of zone architectures, maintenance diagrams, and flowcharts.

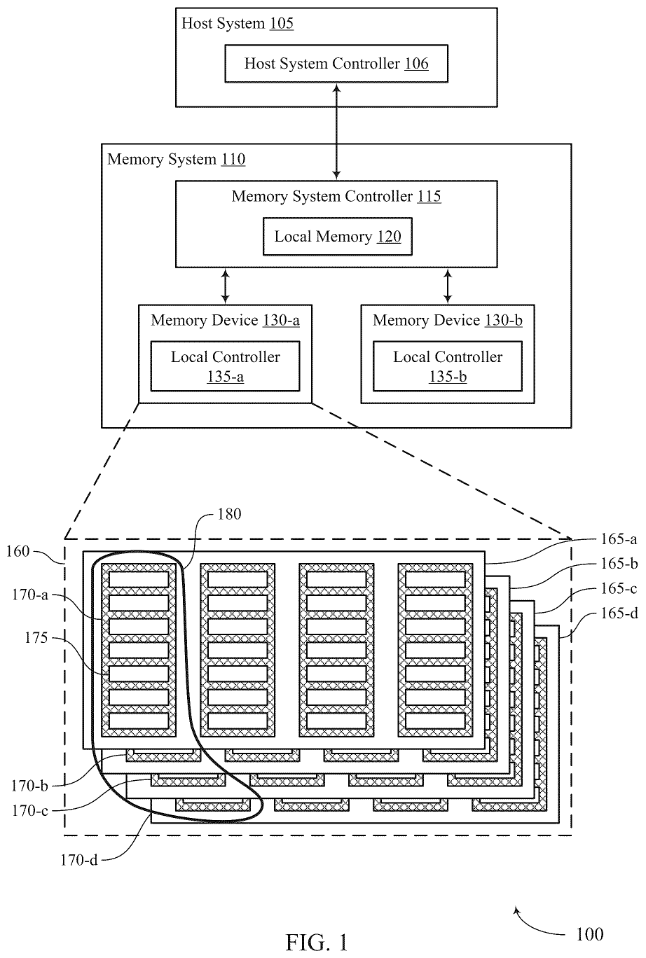

FIG. 1 shows an example of a system 100 that supports zone writing and maintenance for memory systems in accordance with examples as disclosed herein. The system 100 includes a host system 105 coupled with a memory system 110. The system 100 may be included in a computing device such as a desktop computer, a laptop computer, a network server, a mobile device, a vehicle (e.g., train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has not been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support zone writing and maintenance for memory systems. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In accordance with examples as described herein, the memory system 110 may support a zoned write operation, in which data associated with a preferred zone may be written with a first cursor, and data associated with other zones may be written with one or more second cursors. For example, a zone associated with a highest access frequency (e.g., a highest temperature) may be designated as the preferred zone, and may be written to the memory system using an SLC cursor, such that the data associated with the preferred zone is written to SLCs of the memory system 110. In some such examples, other zones may be written to the memory system using a TLC cursor, an MLC cursor, or a QLC cursor (e.g., or an SLC cursor), such that the data associated with the other zones is written to TLCs, MLCs, or QLCs (e.g., or SLCs) of the memory system 110. After writing the data associated with the zones (e.g., the preferred zone and the other zones) to a quantity of virtual blocks of the memory system 110 (e.g., using the respective cursors), the data in a zone may be zonified resulting in all data in a zone being sequentially arranged into the respective, separate, and reordered zones in a maintenance operation, within the quantity of virtual blocks in accordance with access frequencies (e.g., temperature) of the zones. Additionally, or alternatively, performing the maintenance operation may include performing garbage collection for the zones, such that invalid zones may be erased and valid zones may be reconsolidated within the quantity of virtual blocks. In some cases, performing the maintenance operation may include folding data associated with the preferred zone from the SLCs to the TLCs based on initially writing the data with the SLC cursor. Implementing the zoned write operation as described herein may support a reduced quantity of cursors and/or a reduced consumption of write buffer storage capacity for writing the zone data, thereby reducing system resource utilization and decreasing system overhead. Additionally, or alternatively, performing the zoned write operation may support a reduced garbage collection frequency, address mapping table size associated with accessing the zone data, and improved random read latency, among other benefits.

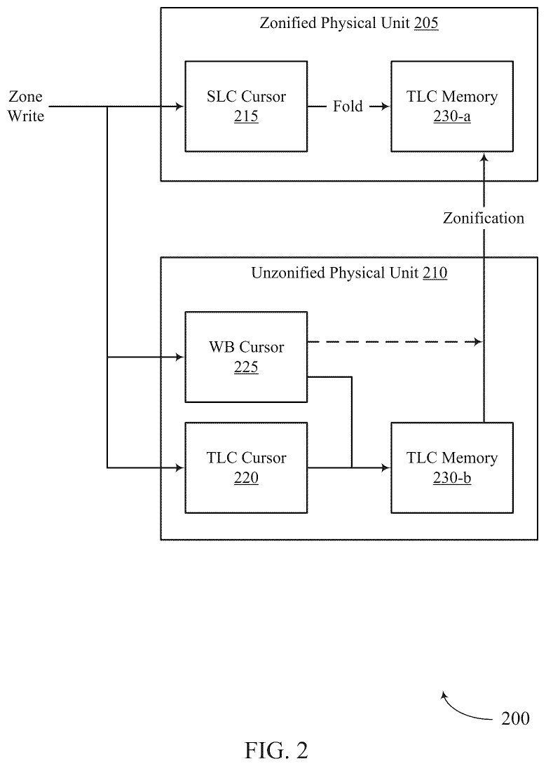

FIG. 2 shows an example of a zone architecture 200 that supports zone writing and maintenance for memory systems in accordance with examples as disclosed herein. The zone architecture 200 may illustrate aspects or operations of a system, which may be an example of a system 100, as described with reference to FIG. 1. For example, the zone architecture 200 illustrates operations associated with performing a zone write operation at a memory system 110, as described with reference to FIG. 1. The zone architecture 200 illustrates a diagram for performing a zone write operation and a maintenance operation.

The zone architecture 200 may be implemented to write data to the memory system 110. As described with reference to FIG. 1, the memory system 110 may include one or more dies 160, each of which including one or more non-volatile memory arrays (e.g., NAND memory arrays). Each non-volatile memory array may include one or more planes 165, where each plane 165 may include a respective set of blocks 170. The blocks 170 may be physical blocks associated with a set of memory cells. The memory system 110 may also include a set of virtual blocks 180, each of which includes one or more blocks 170 from each plane 165 of each die 160. In some cases, the memory cells of the memory system 110 may be non-volatile memory cells, such as NAND memory cells. In some examples, the memory system 110 may support memory cells of different granularities. In some such examples, a portion of the memory cells may be implemented as SLCs, and a portion of the memory cells may be implemented as TLCs, or some other multiplelevel cells (e.g., MLCs, QLCs). For example, the memory system 110 may include TLC memory 230 which includes TLCs configured to store data. In some implementations, the memory system 110 may configure the memory cells to operate as SLCs, TLCs, or some other multiple level cells.

The memory system 110 may support the zone architecture 200 in which data is written to the memory system 110 and organized by zone (e.g., segments of data). In some cases, the data may be written by sequentially writing data to contiguous addresses (e.g., logical addresses, physical addresses) associated with a respective zone. In some cases, data associated with multiple zones may be written to one or more virtual blocks 180 of the memory system 110. For example, a virtual block 180 may include multiple zones, and a size of each zone may be greater than or less than a size of each virtual block 180 (e.g., based on host demands). Because each virtual block 180 includes one or more blocks 170 from each plane 165 of each die 160, each zone may span multiple planes 165 and multiple dies 160. Each zone may be associated with an access frequency, and may include data corresponding to the respective access frequency. For example, a zone associated with a relatively high access frequency may include data that is accessed relatively frequently. In some cases, each zone may be associated with a temperature categorization (e.g., hot, medium-hot, medium, medium-cold, cold, or other temperature categories) corresponding to an access frequency of the respective zone. For example, a hot zone may be a zone associated with a relatively high access frequency, whereas a cold zone may be a zone associated with a relatively low access frequency. In some cases, the memory system 110 may be organized by logical unit, which may be mapped to a zonified physical unit 205 and an unzonified physical unit 210. For example, the zonified physical unit 205 has been zonified (e.g., organizing the data into zones), whereas the unzonified physical unit 210 has not been zonified.

The memory system 110 may include cursors for writing data to the virtual blocks 180 of the memory system 110. Each cursor may be an example of a write pointer and may be configured to write data to the memory cells of the memory system 110. In some cases, writing the data to the memory cells of the memory system 110 may include writing the data to a write buffer of the memory system 110, then writing the data to non-volatile memory cells of the memory system 110. In some such cases, the cursor may be configured to facilitate writing the data to the write buffer or writing the data to the non-volatile memory cells, or a combination thereof. In some cases, the cursors may be associated with granularities, such that different cursors may be associated with different granularities. For example, the memory system 110 may include one or more SLC cursors 215 configured to write data to SLCs using a granularity associated with the SLCs, and one or more TLC cursors 220 (e.g., MLC cursors, QLC cursors) configured to write data to TLCs (e.g., MLCs, QLCs) using a granularity associated with the TLCs (e.g., MLCs, QLCs). The memory system 110 may also include a write booster (WB) cursor 225. The WB cursor 225 may be an example of an SLC cursor, such that the WB cursor 225 is configured to write non-preferred zone data using a granularity associated with the SLCs. In some cases, the WB cursor 225 may be used to write non-preferred zone data during a zone write operation in response to enabling a performance write mode.

The memory system 110 may also include one or more address mapping tables. The one or more address mapping tables may be associated with different granularities. For example, the memory system 110 may include an address mapping table at an address granularity (e.g., PPT3), and an address mapping table at a zone granularity (e.g., PPT2). In some such examples, the address mapping tables may be part of a logical-to-physical (L2P) table, such that each address mapping table may represent a different level of the L2P table. In some implementations, the address mapping table associated with the address granularity may include mappings between logical block addresses and physical block addresses of the memory system 110. In some implementations, the address mapping table associated with the zone granularity may include mappings associated with the zones of the memory system 110.

The memory system 110 may support a zone write operation in accordance with implementing the zone architecture 200. The zone write operation may include writing data to the memory system 110 using the SLC cursor 215, the TLC cursor 220, the WB (e.g., SLC) cursor 225, or a combination thereof. In some cases, the cursor selected for writing the data may be associated with the access frequency of the zone associated with the data. For example, the memory system 110 may select the SLC cursor 215 for writing data associated with a zone, and may select the TLC cursor 220 for writing data associated with another zone.

In some cases, the memory system 110 may select a single zone for writing with the SLC cursor 215. For example, data associated with a preferred zone (e.g., a preferred temperature zone) may be written using the SLC cursor 215. In some such examples, the preferred zone may be selected from the zones in accordance with the access frequency of the preferred zone. In some implementations, the preferred zone may be the zone determined to be associated with the relatively highest access frequency. That is, the preferred zone may have the temperature categorization of hot. Writing the data associated with the preferred zone using the SLC cursor 215 may include writing the data to the write buffer of the memory system 110, then writing the data to the SLCs (e.g., SLC memory). Additionally, writing the data to the SLCs may include writing the data to one or more virtual blocks 180 of the memory system 110. In some examples, the memory system 110 may use the SLC cursor 215 for writing the data associated with the preferred zone if the preferred zone is accessed most frequently and the TLCs are associated with a relatively low access latency. Thus, implementing the SLCs for storing data associated with the preferred zone may enable the data to be accessed with relatively reduced system overhead.

In some cases, the memory system 110 may select other zones for writing with the TLC cursor 220 (e.g., MLC cursor, QLC cursor). For example, data associated with the other zones (e.g., non-preferred zones) may be written using the TLC cursor 220. In some such examples, the other zones may be associated with a relatively lower access frequency than the preferred zone. Writing the data associated with the other zones using the TLC cursor 220 may include writing the data to the write buffer of the memory system 110, then writing the data to the TLC memory 230 (e.g., TLC memory 230-b). Additionally, writing the data to the TLCs may include writing the data to one or more virtual blocks 180 of the memory system 110. In some examples, the memory system 110 may use the TLC cursor 220 for writing the data associated with the other zones if the other zones are accessed less frequently than the preferred zone.

In some cases, the memory system 110 may select a single zone for writing with the WB cursor 225. For example, data associated with a secondary zone (e.g., a secondary preferred temperature zone) may be written using the WB cursor 225. In some such examples, the secondary zone may be selected from the zones in accordance with the access frequency of the secondary zone. In some implementations, the secondary zone may be the zone determined to be associated with the second highest access frequency (e.g., after the preferred zone). Writing the data associated with the secondary zone using the WB cursor 225 may include writing the data to the write buffer of the memory system 110, writing the data to the SLCs (e.g., SLC memory), and subsequently folding (e.g., flushing) the data to TLC memory 230. In some examples, the memory system 110 may use the WB cursor 225 for writing the data associated with the secondary zone if the memory system 110 operates in a performance write mode (e.g., a write booster mode). For example, a host system 105, as described with reference to FIG. 1, may initiate the performance write mode, and the memory system 110 may use the WB cursor 225 for writing the data associated with the secondary zone in response to initiating the performance write mode.

The memory system 110 may support a maintenance operation in accordance with implementing the zone architecture 200. The memory system 110 may perform the maintenance operation according to a level of activity of the memory system 110, or according to a periodicity for performing the maintenance operation, or both. For example, the maintenance operation may be performed in response to the memory system 110 being in an idle state (e.g., not actively performing access operations). Additionally, or alternatively, the maintenance operation may be performed in response to a duration since performing a previous maintenance operation satisfying a threshold duration (e.g., during the night when a user is sleeping and not actively interacting with the memory system 110, among other examples). In some examples, the maintenance operation may be performed in response to the memory system 110 receiving a command from the host system 105 to perform the maintenance operation.

The maintenance operation may include performing zonification, which includes separating (e.g., sequentializing, sorting, reordering) the data stored in the virtual blocks 180 into the respective zones. For example, data written using the TLC cursor 220 may be written such that data associated with various zones may be mixed (e.g., interleaved) within the virtual blocks 180. However, zonification of the data may identify, for each data segment, a zone associated with the respective data segment. The data may be rewritten contiguously with other data segments associated with the respective zone. The maintenance operation may also include reordering (e.g., reorganizing) the zones within the virtual blocks 180 of the memory system 110 according to the access frequency of the zones. In some cases, each virtual block 180 may be associated with storing data with a similar access frequency, such that each virtual block 180 may store one or more zones with a same temperature categorization.

The maintenance operation may include performing garbage collection at a zone granularity. For example, the memory system 110 may identify zones including valid data (e.g., valid zones) and zones including invalid data (e.g., invalid zones), then consolidate the zones including valid data and erase the zones including invalid data. In some such examples, consolidating the zones may include repositioning the zones within the virtual blocks 180 (e.g., a plurality of virtual blocks 180). In some implementations, each zone may include valid or invalid data (e.g., all the data in a zone may be valid or all the data in a zone may be invalid), such that a zone may be identified as an invalid zone if all data in the zone is invalid. In some cases, performing zonification or garbage collection may include performing zonification or garbage collection at TLC memory 230-b (e.g., where the TLC memory 230-b is TLC memory 230-a), or may include transferring the data associated with the zones to another TLC memory 230-a and performing zonification or garbage collection at the TLC memory 230-a. In some implementations, the memory system 110 may support reduced garbage collection frequency in accordance with performing the maintenance operation.

The maintenance operation may include folding the data associated with the preferred zone from the SLCs to TLC memory 230. For example, the data associated with the preferred zone may be initially written to the SLCs by the SLC cursor 215, then after initiating the maintenance operation, the memory system 110 may fold the data from the SLCs to the TLC memory 230. In some such examples, folding the data may include consolidating the data from SLC granularity to TLC granularity, such that each bit of the data (e.g., from a respective SLC) may be combined with two other bits of the data (e.g., from other respective SLCs), and the resulting three data bits may be stored to a TLC of the TLC memory 230. In some cases, the data may be folded from the SLCs to TLC memory 230 prior to performing zonification during the maintenance operation, such that the preferred zone may be reordered with the other zones.

The memory system 110 may access the data associated with the zones in accordance with performing the maintenance operation. In some cases, the memory system may access the data (e.g., in response to an access command, as part of an access operation) using the address mapping table associated with the zone granularity (e.g., PPT2) in response to performing zonification and garbage collection. That is, because the zones are rewritten sequentially (e.g., and the zones are consolidated during garbage collection), the data associated with the zones may be sequential and therefore accessed using the address mapping table associated with the zone granularity. In some cases, because the data may be accessed using the address mapping table associated with the zone granularity, the memory system 110 may support a reduced size of the L2P table. In some cases, the memory system 110 may access the data prior to performing the maintenance operation, in which the zones written by the TLC cursor 220 and the WB cursor 225 are associated with the unzonified physical unit 210. In some such cases, the memory system 110 may access the data using the address mapping table associated with the address granularity (e.g., PPT3). For example, zones may not be sequential at this time, and therefore may not be accessed using the address mapping table associated with the zone granularity (e.g., PPT2).

Performing the zone write operation and the maintenance operation as described herein may support implementing fewer cursors. For example, rather than implementing a cursor for writing data associated with each zone, the memory system 110 may support the SLC cursor 215, the TLC cursor 220, and the WB cursor 225 for writing the data. Thus, the memory system 110 may use fewer system resources and overhead for performing write operations, among other benefits.

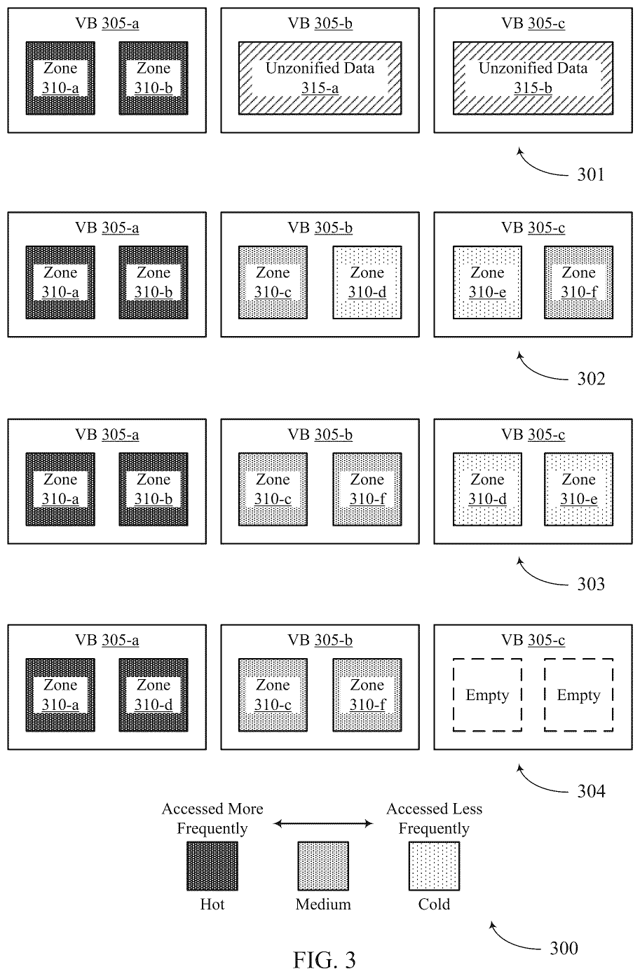

FIG. 3 shows an example of a maintenance diagram 300 that supports zone writing and maintenance for memory systems in accordance with examples as disclosed herein. The maintenance diagram 300 may illustrate aspects or operations of a system, which may be an example of a system 100, as described with reference to FIG. 1. For example, the maintenance diagram 300 illustrates operations associated with performing a maintenance operation at a memory system 110, as described with reference to FIG. 1. The maintenance diagram 300 includes operation 301, operation 302, operation 303, and operation 304, which are associated with performing zonification and garbage collection.

Operation 301 illustrates initially writing data to the memory system 110 in accordance with the zone write operation as described with reference to FIG. 2. For example, the operation 301 includes writing data associated with respective zones 310 to virtual blocks 305 of the memory system 110, which may be examples of virtual blocks 180, as described with reference to FIG. 1. In some such examples, writing the data may include writing the data to a virtual block 305-a, a virtual block 305-b, and a virtual block 305-c such that each virtual block 305 may be configured to store data associated with one or more zones 310. Although not illustrated as such, in some cases, a zone 310 may be shared between the virtual blocks 305. For example, a portion of the zone 310 may be written to the virtual block 305-a and another portion of the zone 310 may be written to the virtual block 305-b. In some cases, the data associated with the zones 310 may be written with cursors, such as an SLC cursor 215, a TLC cursor 220 (e.g., an MLC cursor, a QLC cursor), a WB cursor 225, or any combination thereof, as described with reference to FIG. 2. For example, data associated with one of the zones 310 (e.g., a preferred zone, zone 310-a) may be written with the SLC cursor 215, data associated with another zone 310 (e.g., a secondary zone, zone 310-b) may be written with the WB cursor 225, and data associated with the other zones 310 (e.g., zone 310-d, zone 310-c, zone 310-e, zone 310-f) may be written with the TLC cursor 220. In some such cases, the data written with the SLC cursor 215, the WB cursor 225, or both may be written in an ordered manner. For example, one or more virtual blocks 305, such as the virtual block 305-a, may include the preferred temperature zone(s). In some examples, the data written with the SLC cursor 215 may be written sequentially according to the corresponding zone 310 (e.g., zone 310-a). In some such examples, the data written with the SLC cursor 215 may be zonified (e.g., separated into the respective zone) during writing the data. Likewise, the data written with the WB cursor 225 may also be zonified during writing the data. However, zones written with the TLC cursor 220 may be written such that the data from multiple zones is initially mixed (e.g., data from each zone may be written interleaving with data from other zones). For example, the data in the virtual blocks 305-b and 305-c may be unzonified data 315 (e.g., unzonified data 315-a and unzonified data 315-b, respectively), which includes interleaved or mixed data from multiple zones that have not been zonified during writing the data.

In some cases, the operation 301 may illustrate the preferred zone 310 (e.g., zone 310-a) after folding the data associated with the preferred zone 310 from SLCs to TLCs (e.g., after writing the zone 310-a with the SLC cursor 215 initially). That is, the zones 310 may be written to the virtual blocks 305, where the virtual blocks 305 may be associated with TLC memory (e.g., TLC memory 230, as described with reference to FIG. 2). However, the preferred zone 310 may be written to SLC memory then folded to the virtual blocks 305.

Operation 302 illustrates performing zonification of the unzonified data 315. That is, operation 302 illustrates separating the unzonified data 315 written by the TLC cursor 220 to the virtual blocks 305-b and 305-c into the respective zones 310. For example, data associated with zone 310-c may be initially written intermixingly with data from zone 310-d within the virtual block 305-b as the unzonified data 315-a. Then, the data associated with zone 310-c may be identified and rewritten contiguously to separate the data associated with zone 310-c from the data associated with zone 310-d. Likewise, data associated with zone 310-e may be initially written intermixingly with data from zone 310-f within the virtual block 305-c as the unzonified data 315-b. Then, the data associated with zone 310-e may be identified and rewritten contiguously to separate the data associated with zone 310-e from the data associated with zone 310-f.

In some cases, after initially performing zonfication, the zones 310 may or may not be ordered within the virtual blocks 305 according to access frequency. That is, each zone 310 may be associated with a respective access frequency corresponding to a respective temperature categorization (e.g., hot, medium, cold), however the zones 310 may not be ordered by access frequency initially. Likewise, the zones 310 may not be ordered within the virtual blocks 305 such that each virtual block 305 includes data with a same respective temperature categorization. In some cases, operations 302 and 303 may be performed at the same time in a single operation.

Operation 303 illustrates reordering the zones 310 within the virtual blocks 305. For example, operation 303 illustrates performing a maintenance operation that may include reordering the zones 310 within the virtual blocks 305 according to the access frequency of the zones 310. For example, the zones 310 may be repositioned within the virtual blocks 305 according to an order of access frequency, such that zones 310 accessed more frequently may be first in the order and zones 310 accessed less frequently may be last in the order. That is, the zones 310 may be reordered in accordance with the temperature categorization of the zones 310. For example, zone 310-a may be accessed most frequently, and thus may be ordered first within the virtual blocks 305; whereas zone 310-e may be accessed least frequently, and thus may be ordered last within the virtual blocks 305. In some cases, each virtual block 305 may be configured to store data associated with a similar access frequency. For example, each virtual block 305 may store data associated with zones of a same or similar temperature categorization.

Operation 304 illustrates performing garbage collection at a zone granularity. Performing garbage collection may include identifying zones 310 including valid data and zones 310 including invalid data. In some implementations, each zone may include valid or invalid data, such that a zone may be identified as an valid zone if all data in the zone is valid, or a zone may be identified as an invalid zone if all data in the zone is invalid. The invalid zone(s) may be erased or garbage collected. If the size of an invalid zone is equal to a size of a virtual block 305, or if a single invalid zone 310 is mapped to a single virtual block 305, the zone 310 may be simply erased. In some other cases, if the size of the invalid zone 310 is less than the size of the virtual block 305, the virtual block 305 may contain multiple zones 310, some of which may be valid. Thus, to erase an invalid zone 310 from a virtual block 305, any valid zones in the virtual block 305 may be transferred to another virtual block 305, and the invalid zone may be erased by erasing the virtual block 305. The valid zones may be consolidated within the virtual blocks 305, such that the zones 310 may be repositioned within the virtual blocks 305.

For example, operation 304 illustrates identifying zones 310-d and 310-e are invalid zones, and erasing zones 310-d and 310-e by erasing the virtual block 305-c. However, if zone 310-e were identified as a valid zone and zone 310-d were identified as an invalid zone, the zone 310-e may be transferred to another virtual block 305 (e.g., a new virtual block not illustrated in FIG. 3) prior to erasing the virtual block 305-c (e.g., erasing the zone 310-b). That is, each virtual block 305 may be erased at a block granularity, such that each zone 310 stored within the virtual block 305 may be erased during erasing the virtual block 305. In some such examples, the zones 310 may be consolidated within the virtual blocks 305, such that one or more zones 310 may be transferred between the virtual blocks 305 (e.g., from virtual block 305-b to virtual block 305-a, from virtual block 305-c to virtual block 305-b). In some cases, performing the garbage collection may create “empty” space (e.g., space not storing data) within the virtual blocks 305 for storing additional data. In some such cases, the memory system 110 may write subsequent host data to the “empty” space, such as data associated with other zones, or unzoned data (e.g., data not associated with a zone).

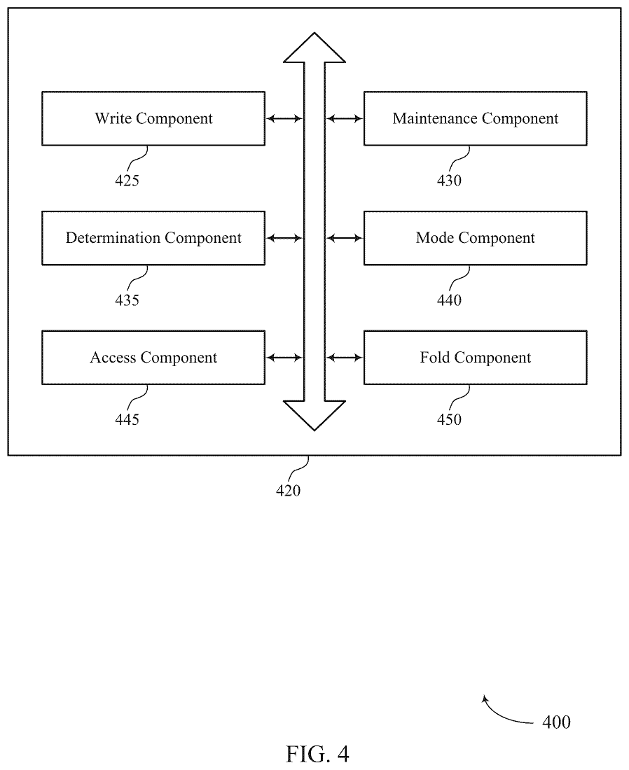

FIG. 4 shows a block diagram 400 of a memory system 420 that supports zone writing and maintenance for memory systems in accordance with examples as disclosed herein. The memory system 420 may be an example of aspects of a memory system as described with reference to FIGS. 1 through 3. The memory system 420, or various components thereof, may be an example of means for performing various aspects of zone writing and maintenance for memory systems as described herein. For example, the memory system 420 may include a write component 425, a maintenance component 430, a determination component 435, a mode component 440, an access component 445, a fold component 450, or any combination thereof. Each of these components, or components of subcomponents thereof (e.g., one or more processors, one or more memories), may communicate, directly or indirectly, with one another (e.g., via one or more buses).

The write component 425 may be configured as or otherwise support a means for writing first data associated with one or more first zones of a plurality of zones to a plurality of virtual blocks of the memory system using a first write cursor. In some examples, the write component 425 may be configured as or otherwise support a means for writing second data associated with one or more second zones of the plurality of zones to the plurality of virtual blocks using a second write cursor. The maintenance component 430 may be configured as or otherwise support a means for performing, based at least in part on using the first write cursor to write the first data and using the second write cursor to write the second data, a maintenance operation to reorder the plurality of zones within the plurality of virtual blocks based at least in part on a respective access frequency associated with each zone.

In some examples, the determination component 435 may be configured as or otherwise support a means for determining that the one or more first zones are associated with a first access frequency, where using the first write cursor to write the first data to the plurality of virtual blocks is based at least in part on the one or more first zones being associated with the first access frequency.

In some examples, the first access frequency is greater than access frequencies associated with the one or more second zones.

In some examples, to support writing the plurality of zones to the plurality of virtual blocks, the write component 425 may be configured as or otherwise support a means for writing the first data with a first granularity associated with single-level cells based at least in part on using the first write cursor. In some examples, to support writing the plurality of zones to the plurality of virtual blocks, the write component 425 may be configured as or otherwise support a means for writing the second data with a second granularity associated with multi-level cells based at least in part on using the second write cursor.

In some examples, the fold component 450 may be configured as or otherwise support a means for folding the first data from the first granularity to the second granularity based at least in part on performing the maintenance operation.

In some examples, to support performing the maintenance operation, the maintenance component 430 may be configured as or otherwise support a means for erasing one or more virtual blocks of the plurality of virtual blocks based at least in part on the one or more virtual blocks comprising one or more zones associated with invalid data. In some examples, to support performing the maintenance operation, the maintenance component 430 may be configured as or otherwise support a means for recording an indication that one or more zones are invalid based at least in part on the one or more zones being associated with invalid data.

In some examples, the mode component 440 may be configured as or otherwise support a means for enabling a performance write mode of the memory system. In some examples, the write component 425 may be configured as or otherwise support a means for writing third data associated with a third zone of the plurality of zones to the plurality of virtual blocks using a third write cursor based at least in part on enabling the performance write mode.

In some examples, the maintenance operation is performed based at least in part on a level of activity of the memory system and a duration since performing a previous maintenance operation satisfying a threshold duration. In some examples, the first write cursor is a single-level cell (SLC) cursor and the second write cursor is a triple-level cell (TLC) cursor. In some examples, each zone includes respective data associated with a respective access frequency.

In some examples, the access component 445 may be configured as or otherwise support a means for initiating an access operation for data stored in one of the plurality of zones. In some examples, the access component 445 may be configured as or otherwise support a means for accessing, based at least in part on initiating the access operation, a first address mapping table of one or more address mapping tables, where the first address mapping table is accessed based at least in part on each zone of the plurality of zones being sequential after performing the maintenance operation.

In some examples, the first address mapping table is associated with a first granularity corresponding to the plurality of zones, and a second address mapping table of the one or more address mapping tables is associated with a second granularity corresponding to a plurality of addresses associated with the memory system.

In some examples, each zone is associated with a respective temperature categorization. In some examples, each temperature categorization corresponds to an access frequency of the respective zone.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

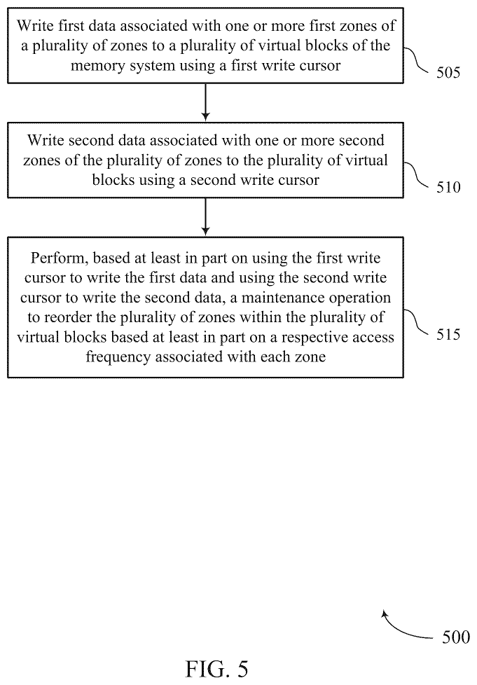

FIG. 5 shows a flowchart illustrating a method 500 that supports zone writing and maintenance for memory systems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include writing first data associated with one or more first zones of a plurality of zones to a plurality of virtual blocks of the memory system using a first write cursor. In some examples, aspects of the operations of 505 may be performed by a write component 425 as described with reference to FIG. 4.

At 510, the method may include writing second data associated with one or more second zones of the plurality of zones to the plurality of virtual blocks using a second write cursor. In some examples, aspects of the operations of 510 may be performed by a write component 425 as described with reference to FIG. 4.

At 515, the method may include performing, based at least in part on using the first write cursor to write the first data and using the second write cursor to write the second data, a maintenance operation to reorder the plurality of zones within the plurality of virtual blocks based at least in part on a respective access frequency associated with each zone. In some examples, aspects of the operations of 515 may be performed by a maintenance component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for writing first data associated with one or more first zones of a plurality of zones to a plurality of virtual blocks of the memory system using a first write cursor; writing second data associated with one or more second zones of the plurality of zones to the plurality of virtual blocks using a second write cursor; and performing, based at least in part on using the first write cursor to write the first data and using the second write cursor to write the second data, a maintenance operation to reorder the plurality of zones within the plurality of virtual blocks based at least in part on a respective access frequency associated with each zone.

Aspect 2: The method, apparatus, or non-transitory computer-readable medium of aspect 1, further including operations, features, circuitry, logic, means, or instructions, or any combination thereof for determining that the one or more first zones are associated with a first access frequency, where using the first write cursor to write the first data to the plurality of virtual blocks is based at least in part on the one or more first zones being associated with the first access frequency.

Aspect 3: The method, apparatus, or non-transitory computer-readable medium of aspect 2, where the first access frequency is greater than access frequencies associated with the one or more second zones.

Aspect 4: The method, apparatus, or non-transitory computer-readable medium of any of aspects 1 through 3, where writing the plurality of zones to the plurality of virtual blocks includes operations, features, circuitry, logic, means, or instructions, or any combination thereof for writing the first data with a first granularity associated with single-level cells based at least in part on using the first write cursor and writing the second data with a second granularity associated with multi-level cells based at least in part on using the second write cursor.

Aspect 5: The method, apparatus, or non-transitory computer-readable medium of aspect 4, further including operations, features, circuitry, logic, means, or instructions, or any combination thereof for folding the first data from the first granularity to the second granularity based at least in part on performing the maintenance operation.

Aspect 6: The method, apparatus, or non-transitory computer-readable medium of any of aspects 1 through 5, where performing the maintenance operation includes operations, features, circuitry, logic, means, or instructions, or any combination thereof for erasing one or more virtual blocks of the plurality of virtual blocks based at least in part on the one or more virtual blocks comprising one or more zones associated with invalid data.

Aspect 7: The method, apparatus, or non-transitory computer-readable medium of any of aspects 1 through 6, where performing the maintenance operation includes operations, features, circuitry, logic, means, or instructions, or any combination thereof for recording an indication that one or more zones are invalid based at least in part on the one or more zones being associated with invalid data.

Aspect 8: The method, apparatus, or non-transitory computer-readable medium of any of aspects 1 through 7, further including operations, features, circuitry, logic, means, or instructions, or any combination thereof for enabling a performance write mode of the memory system and writing third data associated with a third zone of the plurality of zones to the plurality of virtual blocks using a third write cursor based at least in part on enabling the performance write mode.

Aspect 9: The method, apparatus, or non-transitory computer-readable medium of any of aspects 1 through 8, where the maintenance operation is performed based at least in part on a level of activity of the memory system and a duration since performing a previous maintenance operation satisfying a threshold duration.

Aspect 10: The method, apparatus, or non-transitory computer-readable medium of any of aspects 1 through 9, where the first write cursor is a single-level cell (SLC) cursor and the second write cursor is a triple-level cell (TLC) cursor.

Aspect 11: The method, apparatus, or non-transitory computer-readable medium of any of aspects 1 through 10, where each zone includes respective data associated with a respective access frequency.

Aspect 12: The method, apparatus, or non-transitory computer-readable medium of any of aspects 1 through 11, further including operations, features, circuitry, logic, means, or instructions, or any combination thereof for initiating an access operation for data stored in one of the plurality of zones and accessing, based at least in part on initiating the access operation, a first address mapping table of one or more address mapping tables, where the first address mapping table is accessed based at least in part on each zone of the plurality of zones being sequential after performing the maintenance operation.

Aspect 13: The method, apparatus, or non-transitory computer-readable medium of aspect 12, where the first address mapping table is associated with a first granularity corresponding to the plurality of zones, and a second address mapping table of the one or more address mapping tables is associated with a second granularity corresponding to a plurality of addresses associated with the memory system.

Aspect 14: The method, apparatus, or non-transitory computer-readable medium of any of aspects 1 through 13, where each zone is associated with a respective temperature categorization and each temperature categorization corresponds to an access frequency of the respective zone.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
write first data associated with one or more first zones of a plurality of zones to a plurality of virtual blocks of the memory system using a first write cursor;
write second data associated with one or more second zones of the plurality of zones to the plurality of virtual blocks using a second write cursor; and
perform, based at least in part on using the first write cursor to write the first data and using the second write cursor to write the second data, a maintenance operation to reorder the plurality of zones within the plurality of virtual blocks based at least in part on a respective access frequency associated with each zone.

2. The memory system of claim 1, wherein the processing circuitry is further configured to cause the memory system to:
determine that the one or more first zones are associated with a first access frequency, wherein using the first write cursor to write the first data to the plurality of virtual blocks is based at least in part on the one or more first zones being associated with the first access frequency.

3. The memory system of claim 2, wherein the first access frequency is greater than access frequencies associated with the one or more second zones.

4. The memory system of claim 1, wherein writing the plurality of zones to the plurality of virtual blocks comprises the processing circuitry configured to cause the memory system to:
write the first data with a first granularity associated with single-level cells based at least in part on using the first write cursor; and
write the second data with a second granularity associated with multi-level cells based at least in part on using the second write cursor.

5. The memory system of claim 4, wherein the processing circuitry is further configured to cause the memory system to:
fold the first data from the first granularity to the second granularity based at least in part on performing the maintenance operation.

6. The memory system of claim 1, wherein performing the maintenance operation comprises the processing circuitry configured to cause the memory system to:
erase one or more virtual blocks of the plurality of virtual blocks based at least in part on the one or more virtual blocks comprising one or more zones associated with invalid data.

7. The memory system of claim 1, wherein performing the maintenance operation comprises the processing circuitry configured to cause the memory system to:
record an indication that one or more zones of the plurality of zones are invalid based at least in part on the one or more zones being associated with invalid data.

8. The memory system of claim 1, wherein the processing circuitry is further configured to cause the memory system to:
enable a performance write mode of the memory system; and
write third data associated with a third zone of the plurality of zones to the plurality of virtual blocks using a third write cursor based at least in part on enabling the performance write mode.

9. The memory system of claim 1, wherein the maintenance operation is performed based at least in part on a level of activity of the memory system and a duration since performing a previous maintenance operation satisfying a threshold duration.

10. The memory system of claim 1, wherein the first write cursor is a single-level cell (SLC) cursor and the second write cursor is a triple-level cell (TLC) cursor.

11. The memory system of claim 1, wherein each zone comprises respective data associated with a respective access frequency.

12. The memory system of claim 1, wherein the processing circuitry is further configured to cause the memory system to:
initiate an access operation for data stored in one of the plurality of zones; and
access, based at least in part on initiating the access operation, a first address mapping table of one or more address mapping tables, wherein the first address mapping table is accessed based at least in part on each zone of the plurality of zones being sequential after performing the maintenance operation.

13. The memory system of claim 12, wherein the first address mapping table is associated with a first granularity corresponding to the plurality of zones, and a second address mapping table of the one or more address mapping tables is associated with a second granularity corresponding to a plurality of addresses associated with the memory system.

14. The memory system of claim 1, wherein:
each zone is associated with a respective temperature categorization, and
each temperature categorization corresponds to an access frequency of the respective zone.

15. A non-transitory computer-readable medium storing code, the code comprising instructions executable by one or more processors to:
write first data associated with one or more first zones of a plurality of zones to a plurality of virtual blocks of a memory system using a first write cursor;
write second data associated with one or more second zones of the plurality of zones to the plurality of virtual blocks using a second write cursor; and
perform, based at least in part on using the first write cursor to write the first data and using the second write cursor to write the second data, a maintenance operation to reorder the plurality of zones within the plurality of virtual blocks based at least in part on a respective access frequency associated with each zone.

16. The non-transitory computer-readable medium of claim 15, wherein the instructions are further executable by the one or more processors to:
determine that the one or more first zones are associated with a first access frequency, wherein using the first write cursor to write the first data to the plurality of virtual blocks is based at least in part on the one or more first zones being associated with the first access frequency.

17. The non-transitory computer-readable medium of claim 16, wherein the first access frequency is greater than access frequencies associated with the one or more second zones.

18. The non-transitory computer-readable medium of claim 15, wherein the instructions to write the plurality of zones to the plurality of virtual blocks are executable by the one or more processors to:
write the first data with a first granularity associated with single-level cells based at least in part on using the first write cursor; and
write the second data with a second granularity associated with multi-level cells based at least in part on using the second write cursor.

19. The non-transitory computer-readable medium of claim 18, wherein the instructions are further executable by the one or more processors to:
fold the first data from the first granularity to the second granularity based at least in part on performing the maintenance operation.

20. The non-transitory computer-readable medium of claim 15, wherein the instructions to perform the maintenance operation are executable by the one or more processors to:
erase one or more virtual blocks of the plurality of virtual blocks based at least in part on the one or more virtual blocks comprising one or more zones associated with invalid data.

21. The non-transitory computer-readable medium of claim 15, wherein the instructions to perform the maintenance operation are executable by the one or more processors to:
record an indication that one or more zones of the plurality of zones are invalid based at least in part on the one or more zones being associated with invalid data.

22. The non-transitory computer-readable medium of claim 15, wherein the instructions are further executable by the one or more processors to:
enable a performance write mode of the memory system; and
write third data associated with a third zone of the plurality of zones to the plurality of virtual blocks using a third write cursor based at least in part on enabling the performance write mode.

23. The non-transitory computer-readable medium of claim 15, wherein the maintenance operation is performed based at least in part on a level of activity of the memory system and a duration since performing a previous maintenance operation satisfying a threshold duration.

24. The non-transitory computer-readable medium of claim 15, wherein the first write cursor is a single-level cell (SLC) cursor and the second write cursor is a triple-level cell (TLC) cursor.

25. A method by a memory system, comprising:
writing first data associated with one or more first zones of a plurality of zones to a plurality of virtual blocks of the memory system using a first write cursor;
writing second data associated with one or more second zones of the plurality of zones to the plurality of virtual blocks using a second write cursor; and
performing, based at least in part on using the first write cursor to write the first data and using the second write cursor to write the second data, a maintenance operation to reorder the plurality of zones within the plurality of virtual blocks based at least in part on a respective access frequency associated with each zone.
